(19) United States
(12) Patent Application Publication
(10) Pub. No.: US 2007/0267270 A1
(43) Pub. Date: Nov. 22, 2007

(54) Coupling arrangment

(75) Inventors: Jorg Sudau, Niederwerrn (DE); Peter Fenn, Waigolshausen (DE); Rudiger Lotze, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/800,575

(22) Filed: May 7, 2007

(30) Foreign Application Priority Data
May 18, 2006 (DE) 10 2006 023 289.5

(51) Int. Cl. F16D 25/10; F16D 13/72

(52) U.S. Cl. 192/87.11; 192/70.12; 192/55.61

(57) ABSTRACT

A coupling arrangement includes a first clutch device for establishing a working connection between an electric machine and an internal combustion engine and a second clutch device for establishing a working connection between at least one of the machines and a takeoff. Each of the two clutch devices has its own clutch components in the form of at least one piston and a predetermined number of clutch elements. By means of the piston in question, a pressure space is at least essentially sealed off from a cooling space, which holds the clutch elements. Each of the pressure spaces of the two clutch devices has its own supply line, whereas only one of the cooling spaces of the two clutch devices has its own supply line, the cooling space of the other clutch device being connected by a line leading to the cooling space of the first-mentioned clutch device.

### BACKGROUND OF THE INVENTION

1. Field of the Invention

The invention pertains to a coupling arrangement for connecting an internal combustion engine to at least one of an electric machine and a takeoff, the arrangement including a first clutch having first clutch components for establishing a working connection between the engine and the electric machine, a second clutch having second clutch components for establishing a working connection between the takeoff and at least one of the engine and the electric machine, and a fluid supply source connected to at least one of the clutches by at least one fluid supply line.

2. Description of the Related Art

A coupling arrangement of this type is known from U.S. Pat. No. 6,668,953. This coupling arrangement has a first clutch device for establishing a working connection between an electric machine and an internal combustion engine when certain clutch components are in an engaged position and for separating the two machines when certain clutch components are in the disengaged position and a second clutch device for establishing a working connection between at least one of the machines and a takeoff, such as a gearbox input shaft, when certain clutch components are in an engaged position and for separating the minimum of one machine from the takeoff when certain clutch components are in the disengaged position.

The clutch components in each of the two clutch devices consist of a diaphragm spring, a pressure plate, a clutch disk, and a support plate, where the clutch disk, depending on the position of an assigned clutch-release mechanism, either allows torque to be transmitted by frictional interaction with the pressure plate on one side and with a support plate on the other side or interrupts that transmission. At least the clutch-release mechanism assigned to the first clutch device is actuated hydraulically. So that it can be supplied with fluid medium, it must therefore be connected to a supply source by way of at least one supply line and also connected to a fluid reservoir by way of at least one discharge line.

These types of clutch disks must be made with very large diameters if they are to transmit a sufficient amount of torque. This either makes it more difficult to accommodate the electric machine or leads to an outside diameter which cannot usually be tolerated by auto manufacturers. It also leads to a coupling arrangement with an unacceptably large overall weight. When they have become heated as a result of slippage, furthermore, these clutch disks are almost impossible to cool with ambient air. It must therefore be anticipated, especially in high-performance vehicles, that the friction linings will overheat very quickly and thus be damaged or possibly even destroyed. In addition, the combination of a hydraulic clutch-release mechanism and dry-running clutch disks can also lead to critical phenomena when there are leaks in the clutch-release mechanism, because the frictional properties of the friction linings provided on the clutch disk rapidly deteriorate when they become wetted with fluid medium.

### SUMMARY OF THE INVENTION

The invention is based on the task of designing a coupling arrangement of this type in such a way that, even though it is provided with compact radial dimensions, it is still capable of transmitting high torques and can also be cooled efficiently through the use of a simple design.

According to the invention, each of the clutch devices of the coupling arrangement is designed with its own pressure space and with it own cooling space, which is separated from the pressure space by a piston acting as a clutch component, the cooling space being designed to hold at least one clutch element also serving as a clutch component. By connecting the cooling space of the one clutch device to a supply line and by connecting the cooling space of the other clutch device to the cooling space of the first-mentioned clutch device, it is ensured, first, that the pressure spaces can be supplied promptly with fluid medium so that the pressure can be built up in them quickly and the piston in question can be actuated quickly, and second, that the cooling spaces can also be supplied promptly with fluid medium so that the heat can be dissipated efficiently from the friction area of the clutch elements.

This prompt supply both of the pressure spaces and of the cooling spaces with fresh fluid medium takes place in a way which allows a simple design of the coupling arrangement with a minimum of supply lines, that is, with a minimum of lines which must be connected to the supply source. Limiting the number of supply lines can be accomplished in particular by connecting the cooling space of one of the two clutch devices not directly to the supply source but rather in the manner of a series circuit to the cooling space of the other clutch device by way of a connecting line. It is easy to see that the advantage of this type of arrangement will be fully exploited when the cooling space of the clutch device positioned closer to the supply source is supplied with fluid medium directly by a supply line, whereas the cooling space of the clutch device positioned farther away from the supply source is supplied by way of the cooling space of the other clutch device. In this way, not only the number of supply lines connected to the supply source but also their length within the coupling arrangement is reduced. In addition, both the complexity of the route along which the medium flows and the losses caused by flow resistance are decreased. Thanks to the previously mentioned advantages, the supply source can be designed with a more modest power capacity, and the power to be demanded from one of the machines, i.e., from the internal combustion engine or the electric machine, can also be reduced.

Supplying the cooling space of one of the clutch devices by way of the cooling space of the other clutch device is advantageous especially in clutch devices which rotate at the speed of the drive around an axis of rotation at least essentially identical to the axis of rotation of the drive and in which, furthermore, the clutch device closer to the supply source is filled at least essentially full with fluid medium. For it is precisely in cases such as this that, beyond the fact that the cooling space of the latter clutch device can be supplied quickly with fresh fluid medium from the supply source, the fluid medium already present in the cooling space is mixed so intensively that it arrives in the cooling space of the other clutch device without having been heated to any significant degree and can thus fulfill its function there effectively.

An especially advantageous application of the inventive design of the coupling arrangement is present when each of the clutch devices is designed as a 3-line system. Precisely in the case of this type of clutch design, two lines are required for each cooling space, namely, one to fill the cooling space and one to empty it, so that the ability to eliminate one of the supply lines leading to the supply source becomes especially advantageous.

A discharge line leading to a fluid reservoir, furthermore, especially the discharge line on the clutch device farther away from the supply source, can be eliminated completely if the cooling space of this clutch device is in direct flow connection with a discharge route located inside a gearbox housing surrounding the coupling arrangement and which therefore returns the fluid medium primarily inside the gearbox housing to the fluid reservoir, which is usually in flow connection with the supply source.

In contrast to the cooling spaces of the two clutch devices, their pressure spaces are preferably connected in parallel to each other, each pressure space being connected by its own supply line to the supply source, so that they can always be filled quickly to build up the pressure, which is necessary for fast actuation of the clutch.

When the supply lines, possibly also a discharge line on the clutch device closer to the supply source, are designed in the radial area of a takeoff or hub surrounding the takeoff, especially when the takeoff is in the form of the gearbox input shaft, all of these lines will be concentrated within a short radial distance of the axis of rotation of the coupling arrangement. As a result, the effects on the flow of fluid medium caused by centrifugal force can be minimized, and at the same time it is ensured that the coupling arrangement will be compact in spite of the presence of these lines.

The two clutch devices are preferably supplied by a supply source located on the takeoff side. To this extent, therefore, the second clutch device, i.e., the one which makes or breaks the working connection between a drive such as an internal combustion engine or an electric machine and a takeoff such as a gearbox input shaft, will be closer to the supply source than the clutch device which makes or breaks the working connection between the internal combustion engine and the electric machine, which means that the cooling space of the second clutch device is advantageously connected directly to the supply source, whereas the cooling space of the first clutch device is connected to the source by way of the cooling space of the second clutch device.

Designing the two clutch devices as parts of a common clutch module facilitates installation, since a module can be installed easily. An especially advantageous design of the clutch module can be obtained by designing it to hold, in addition, the rotating part of the electric machine, that is, its rotor, which rotates around the axis of rotation of the clutch arrangement. In a special design, therefore, the coupling arrangement has a coupling element, which not only separates the cooling space of the second clutch device from the pressure space and cooling space of the first clutch device but also carries the rotor of the electric machine. Additional advantageous embodiments and effects of the coupling element can be derived in detail from the claims.

The coupling arrangement is preferably preceded by a torsional vibration damper with a torsion damper hub, which establishes the connection for rotation in common with the coupling arrangement. Especially when this torsion damper hub is connected by means of axially elastic elements to an element of a takeoff-side transmission element of the torsional vibration damper such as a hub disk, not only vibrations in the rotational direction, i.e., torsional vibrations, but also vibrations in the axial direction, i.e., wobbling, can be damped. This torsional vibration damper is advantageously mounted nonrotatably on the internal combustion engine. Because of the torsion damper hub, which establishes the connection for rotation in common with the coupling arrangement, the torsional vibration damper promotes the design of the coupling arrangement as a clutch module. This is especially true if the module is provided with a bearing journal, which allows considerable ease of installation, especially when the connection for rotation in common is designed in the form of a set of teeth on the torsion damper hub and another set of teeth on the bearing journal. If the bearing journal is also designed with a recess for the transmission input shaft, the latter can be centered with respect to the internal combustion engine and therefore the effect of wobbling vibrations reduced. Finally, providing the coupling arrangement with a partition wall makes it possible to seal off the wet space assigned to the coupling arrangement, i.e. the space formed at least by the cooling space and the discharge route of the drive-side clutch device, against the dry surrounding space, in which the torsional vibration damper and the internal combustion engine are located.

Several seals are provided between the individual lines of the coupling arrangement. To promote an effective and durable sealing action, each seal is assigned to a bearing and/or located in a position in which the components of the coupling arrangement to be sealed off against each other execute only a comparatively small amount of relative movement in the sealing plane. To provide the necessary effect, these seals comprise in particular first seals, which are located radially between the coupling element hub and the gearbox input shaft, which is centered versus the coupling element hub by at least one bearing; a second seal, located radially between the support shaft and the second takeoff-side clutch element carrier, especially in this case radially between the support shaft and the hub of the second takeoff-side clutch element carrier; and third seals, located radially between the clutch housing hub and the gearbox housing of the gearbox, where the clutch housing hub is centered on the gearbox housing by at least one bearing.

In addition, through the appropriate layout of the lines and sections of lines, it is ensured that the fluid medium can be supplied and discharged with the least possible hindrance and thus with the least possible drop in pressure. Thus, for example, the hub of the second takeoff-side clutch element carrier can have a line for the fluid medium.

In cases where it must be anticipated that the fluid medium flowing through the discharge route will become significantly contaminated with dirt particles originating from the clutch devices, there exists the possibility of providing not only the clutch device closer to the supply source with a clutch housing, but also the clutch device farther away from the supply source. As a result of the clutch housing assigned to the latter, the fluid medium present in the cooling space of this clutch device can enter the discharge route only by way of at least one passage, preferably by way of several passages. It is advantageous for this passage to be provided a predetermined radial distance inside a radially outer axial housing wall of the clutch housing. As a result of this predetermined radial gap, centrifugal force and the higher specific gravity of the dirt particles versus the fluid medium allow a fluid sump with a high concentration of dirt particles to form inside the axial housing wall, whereas the fluid medium radially inside this fluid sump enters the discharge route essentially uncontaminated with dirt particles. Because of this measure, dirt particles are prevented from forming deposits as a result of magnetic fields in the radial area of the electric machine and especially in the gap between the electric machine's rotor and its stator. Such deposits would reduce the gap and could lead to damage or even to the destruction of the electric machine during relative movement between the rotor and the stator.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a cross section through a coupling arrangement with two clutch devices, one of which has a clutch housing; and

FIG. 2 is similar to FIG. 1 but shows a second clutch device with a clutch housing.

### DETAILED DESCRIPTION OF THE PRESENTLY PREFERRED EMBODIMENTS

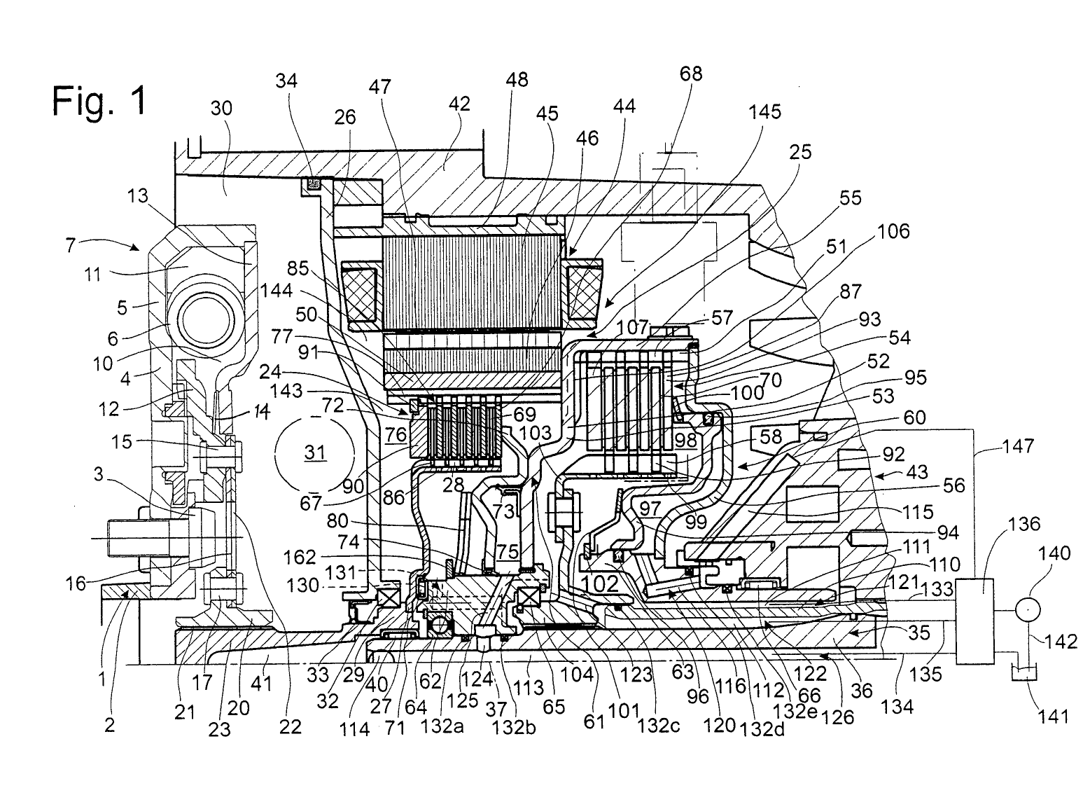

FIG. 1 shows in schematic fashion a crankshaft 2 of an internal combustion engine 1, to which a primary flange 4 of a torsional vibration damper 7 is connected by fastening elements 3. A cover plate 13 is attached to the radially outer area of the primary flange 4. This cover plate and the primary flange 4 together form the boundaries of a grease chamber 10, which serves to hold an energy storage set 6 acting in the circumferential direction, which is supported radially and possibly also circumferentially by slide elements 11. The energy storage set 6 is driven by the primary flange 4 and/or the cover plate 13 upon the introduction of torsional vibrations at the crankshaft 2, and at the other end, it is supported against a hub disk 12. The radially inner area of this hub disk 12 serves to hold axially elastic elements 16 by means of first connecting means 15. The axially elastic elements 16 for their own part carry a torsion damper hub 20 by means of second connecting means 17. The primary flange 4, the energy storage set 6, the slide elements 11, and the cover plate 13 together form a drive-side transmission element 5 of the torsional vibration damper 7, whereas the hub disk 12, the axially elastic elements 16, and the torsion damper hub 20 together form a takeoff-side transmission element 22 of the torsional vibration damper 7. Between the two transmission elements 5 and 22, or, more precisely, between the hub disk 12 and the cover plate 13, an axial energy storage device 14 is provided, which, first, keeps the two transmission elements 5 and 22 a certain axial distance apart and, second, is intended to prevent the fluid medium present in the grease chamber 10 from escaping.

To return to the torsion damper hub 20 of the takeoff-side transmission element 22, this hub has a set of teeth 21 by which it engages nonrotatably but with freedom of axial movement with a bearing journal 23 of a coupling arrangement 25, which, as will be explained again in more detail later, has a first clutch device 24 and a second clutch device 54.

The bearing journal 23 of the coupling arrangement 25 carries on its radially outer side a bearing 32, by which the bearing journal 23 is to be centered by means of a partition wall 26 on a gearbox housing 42 of a gearbox 43. The partition wall 26 is supported for this purpose by way of a radially outer seal 34 against an inner wall of the gearbox housing 42 and by way of a radially inner seal 33 against the outside diameter of the bearing journal 23. The partition wall separates an essentially dry surrounding space 30, through which a shaft 31 of a drive train can be suitably passed, from a wet space 143, which is located on the other side of the partition wall 26 and which serves to hold the two clutch devices 24 and 54 of the coupling arrangement 25 and also to hold an electric machine 44. This machine has a stator 45, which is fastened by a retainer 48 to an inside wall of the gearbox housing 42, and which acts by way of a gap 47 on a rotor 46. The rotor 46, like the torsional vibration damper 7, the crankshaft 2 of the internal combustion engine 1, the bearing journal 23 of the coupling arrangement 25, and a takeoff 35 in the form of a gearbox input shaft 36, rotate around an axis of rotation 37, which is at least essentially the same for all of the previously mentioned components. It should also be observed here supplementally that the end of the bearing journal 23 facing the gearbox input shaft 36 is provided with a recess 41, in which the free, drive-side end of the gearbox input shaft 36 engages axially. The input shaft is centered here by a radial bearing 40, which serves as a pilot bearing, on the bearing journal 23 and thus on the gearbox housing 42.

At the end facing away from the crankshaft 2, the bearing journal 23 is connected nonrotatably to a first drive-side clutch element carrier 27 and can therefore be considered functionally a part of this first drive-side clutch element carrier 27. The radially outer area of the clutch element carrier 27 is connected nonrotatably by way of a set of teeth 28 to radially inner first clutch elements 67 of the first clutch device 24. These radially inner first clutch elements 67, which are in the form of inner plates, are moved into working connection with radially outer first clutch elements 68 in the form of outer plates when a first piston 72 of the first clutch device 24 exerts axial pressure on the first clutch elements 67, 68 in the direction toward the partition wall 26. As a result of this pressure, the first clutch elements 67, 68 come to rest axially against each other under the effect of friction and thus form a friction area 69. Ultimately, the first clutch element 67 closest to the partition wall 26 comes to rest by way of the last plate 90 against an axial backup ring 91, which is stationary with respect to the first drive-side clutch element carrier 27. When, however, the axial pressure being exerted by the piston 72 on the first clutch elements 67, 68 is released, the frictional effect present in the friction area 69 at least partially disappears. In this latter state of the piston, the first clutch device 24 is in its released position, whereas, when the piston 72 is exerting axial pressure on the first clutch elements 67, 68, the first clutch device 24 is in its engaged position. Thus the piston 72 and the first clutch elements 67, 68 together form the clutch components 85 of the first clutch device 24.

The radially outer first clutch elements 68 are connected for rotation in common by a set of teeth 77 to a first takeoff-side clutch element carrier 50 of the first clutch device 24, the carrier being connected nonrotatably to a second drive-side clutch element carrier 51 of the second clutch device 54. The second drive-side clutch element carrier 51 consists of an at least essentially radial drive-side radial housing wall 53 and an axial housing wall 55, which is formed in the radially outer area of the radial housing wall 53. The free, takeoff-side end of this axial housing wall 55 holds another takeoff-side radial housing wall 56 in nonrotatable, sealed fashion, which cooperates with the drive-side radial housing wall 53 and the axial housing wall 55 to form the clutch housing 60 of the second clutch device 54, which is at least essentially sealed off from the wet space 143 and from the gearbox housing 42.

Before the second clutch device 54 is discussed in detail, it should first be pointed out that the first takeoff-side clutch element carrier 50 and the second drive-side clutch element carrier 51 together form a coupling element 61 of the coupling arrangement 25. This coupling element 61 is an essential feature which makes it possible to design the coupling arrangement 25 as a clutch module 145.

The second drive-side clutch element carrier 51 is connected nonrotatably by a set of teeth 57 to radially outer second clutch elements 93, which can be brought into working connection with radially inner second clutch elements 92 by way of a friction area 70, where the radially inner second clutch elements 92 are connected nonrotatably to a second takeoff-side clutch element carrier 103 of the second clutch device 54 by a set of teeth 58. The second clutch device 54 is in its engaged position when the piston 94 is exerting axial pressure on the second clutch elements 92, 93 by way of a contact-mediating energy storage device 100, which is intended to make the engagement process proceed more “softly”, so that the second clutch elements 92, 93 come to rest by way of the last plate 107 against an end stop 106 on the drive-side radial housing wall 53. The second clutch device 54 is in its released position, however, when the axial force exerted by the piston 94 is reduced to such an extent that the frictional effect present in the friction area 70 between the second clutch elements 92, 93 has at least essentially disappeared.

The radially inner area of the coupling element 61, specifically of its drive-side radial housing wall 53, is connected nonrotatably to a coupling element hub 62, which is centered with respect to the gearbox input shaft 36 by a bearing 64 and positioned axially by means of another bearing 71 versus the first drive-side clutch element carrier 27 and thus versus the bearing journal 23 of the coupling arrangement 25. The coupling element hub 62 for its own part centers the hub 104 of the second takeoff-side clutch element carrier 103 by means of another bearing 65.

The first clutch device 24 has a pressure space 75, the boundaries of which are formed by the piston 72 on one side and by the drive-side radial housing wall 53 of the second clutch device 54 on the other. This pressure space is sealed off by seals 73, 74 against a first cooling space 76, in which the first clutch elements 67, 68 are located. This cooling space 76 holds an axial energy storage device 80, which is formed preferably by a stack of two springs, and which is supported at one end against the piston 72 and at the other end against a retainer 162 permanently connected to the coupling element hub 62. The axial energy storage device 80 serves to exert force on the piston 72 in the direction toward the drive-side radial wall 53 of the second clutch device 54. The goal of this measure is to prevent the piston 72 from making undesirable contact with the first clutch elements 67, 68 when in the disengaged position and thus to avoid the occurrence of undesirable torque transmission by the first clutch device 24.

As a result of the rotation of the coupling arrangement 25 around the axis of rotation 37, fluid medium present in the cooling space 76 is accelerated radially outward. It then passes through flow passages 86 in the first drive-side clutch element carrier 27 and thus efficiently cools the friction area 69 of the first clutch device 24. After passing through the friction area 69, the fluid medium arrives via the set of teeth 77 of the first takeoff-side clutch element carrier 50 in a discharge route 144, which leads farther outward in the radial direction and which is part of the wet space 143. The fluid can thus return via this discharge route 144, which extends as much as possible within the gearbox housing 42, to a fluid reservoir 141, illustrated in merely schematic fashion.

As FIG. 1 clearly shows, the fluid reservoir 141, like a supply source 140 for fluid medium connected to the reservoir by a connecting line 142, is provided on the takeoff-side of the coupling arrangement 25, so that, by way of an open-loop and/or closed-loop control unit 136, it can supply fluid medium to the infeed lines 133, 134, and 147 or accept fluid medium from an outfeed line 135.

The second clutch device 54 also has a pressure space 97, located axially between the piston 94 and the adjacent takeoff-side radial housing wall 56 of the clutch housing 60, for which reason the piston is separated radially on the outside and radially on the inside by seals 95, 96 from a cooling space 98, in which the second clutch elements 92 and 93 are located, which act jointly with the piston 94 as clutch components 146 of the second clutch device 54. The piston 94 is mounted with freedom of axial movement on a clutch housing hub 63 of the clutch housing 60 of the second clutch device 54, where the clutch housing hub 63 and a stationary support shaft 110, which is designed as a hollow shaft, form the radial boundaries of a first ring-shaped channel 111, whereas the support shaft 110 for its own part and the gearbox input shaft 36 form the boundaries of a second ring-shaped channel 112. Finally, a central bore 113 is provided in the gearbox input shaft 36; this bore is sealed off on the drive side by a plug 114, which is inserted into the end of the bore.

To return to the clutch housing hub 63, a line 116 passes through the hub. This line opens out into the pressure space 97 of the second clutch device 54 and is connected to a line 115 in the gearbox 43, where the line 115 is connected to the previously mentioned infeed line 147 of the open-loop and/or closed-loop control unit 136. The lines 115 and 116 possibly together with the infeed line 147 form a first supply line 120, through which the pressure space 97 of the second clutch device 54 is filled with fluid medium.

A second supply line 121 is created on the basis of the first ring-shaped channel 111 and possibly the infeed line 133 and serves to connect the cooling space 98 of the second clutch device 54 to the open-loop and/or closed-loop control unit 136. Fluid medium flows from the second supply line 121 radially outward, whereupon it flows through the flow passages 99 present in the second takeoff-side clutch element carrier 103 to supply the friction area 70 of the second clutch device 54. After flowing through this friction area 70, the fluid medium is deflected radially inward again at the set of teeth 51 of the second drive-side clutch element carrier 51, and then flows radially inward, arriving in an axial area between the drive-side radial housing wall 53 of the clutch housing 60 and the second takeoff-side clutch element carrier 103, this area extending all the way to the hub 104 of the carrier. Once there, the fluid passes through the bearing 65 at least essentially in the axial direction. Then the fluid medium passes through another line 130, which acts as a connecting line 131, formed in the coupling element hub 62 and shown in broken line, and arrives in the cooling space 76 of the first clutch device 24, where, in the manner previously described, the fluid medium arrives at the friction area 69 of this clutch device 24 via the flow passages 86. In contrast to the cooling space 98 of the second clutch device 54 closer to the supply source 140, the cooling space 76 of the first clutch device 24 farther away from the supply source 140 is not supplied with fresh fluid medium from the supply source through its own separate supply line but rather merely via the connecting line 131 leading to the cooling space 98 of the second clutch device 54. As a result, one of the supply lines can be eliminated, but this is uncritical, because both clutch devices 24 and 54 rotate around the axis of rotation 37 and thus bring about an enormous amount of circulation and therefore of mixing of the fluid medium inside the cooling space 98 of the second clutch device 54. As a result, it is guaranteed that the fluid medium which has been sent onward by the connecting line 131 to the cooling space 76 of the first clutch device 24 is sufficiently cool and is therefore still fully capable of fulfilling its intended function in the first clutch device 24 as well.

Only a portion of the fluid medium flowing radially inward between the drive-side radial housing wall 53 and the second takeoff-side clutch element carrier 103 arrives via the bearing 65 and the connecting line 131 at the cooling space 76 of the first clutch device 24. The remaining portion of this fluid medium flows through a line 123 provided in the hub 104 of the second takeoff-side clutch element carrier 103 and thus arrives in the second ring-shaped channel 112, so that the line 123 and the second ring-shaped channel 112 and possibly the outfeed line 135 together form a discharge line 122 for the second clutch device 54. The departing fluid medium arrives via the outfeed line 135 at the open-loop and/or closed-loop control unit 136, and from there it returns to the fluid reservoir 141. From there, possibly after intermediate cooling, the fluid medium can be sent back through the connecting line 142 to the supply source 140 and is thus available again to the infeed lines 133, 134, and 147 for filling the supply lines 120, 121, and 126.

In conclusion it remains to be said that the second clutch device 54 also has an axial energy storage device 101, which for its own part is supported on one side against the piston 94 and on the other side against a backup ring 102, recessed into the clutch housing hub 63, and which exerts force on the piston 94 in the direction away from the clutch elements 92, 93. In the case of the second clutch device 54 as well, the purpose of the axial energy storage device 101 is to prevent undesirable friction between the clutch elements 92, 93 after the clutch device 54 has been released.

Of course, the individual supply lines 120, 121, and 126 must be isolated from each other in a leakproof manner, for which reason seals 132a to 132e are provided at the appropriate points. Specifically, there are first seals 132a and 132b, which are located radially between the coupling element hub 62 and the gearbox input shaft 36, which is centered versus the coupling element hub 62 by at least one bearing 64. There is also a second seal 132c, located radially between the support shaft 110 and the hub 104 of the takeoff-side clutch element carrier 103, this hub executing only slight radial movement relative to this support shaft 110. Finally, there are the third seals 132d and 132e, located radially between the clutch housing hub 63 and the gearbox housing 42 of the gearbox 43, where the clutch housing hub 63 is centered versus the gearbox housing 42 by at least the bearing 66.

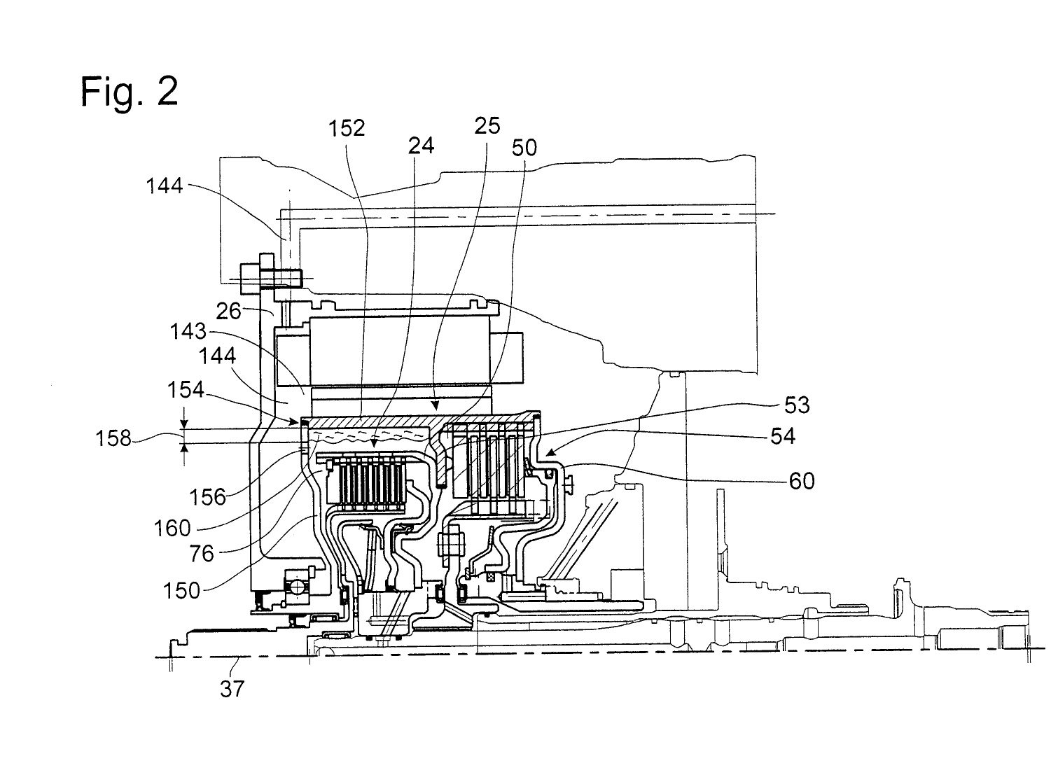

FIG. 2 shows a coupling arrangement 25 in which the second clutch device 54 has a clutch housing 60 with a drive-side radial housing wall 53 and the first clutch device 24 has a clutch housing 154 with a drive-side housing wall 150. An axial housing wall 152 adjoins the housing wall 150 on the radially outward side, and the drive-side radial housing wall 53 of the second clutch housing 60. So that fluid medium can pass from the cooling space 76 of the first clutch device 24 into the discharge route 144, the drive-side housing wall 150 of the first clutch device 24 is provided with at least one passage 156, preferably a plurality of passages 156, at a predetermined radial distance 158 inside the axial housing wall 152. Because of this radial gap 158, the centrifugal force acting during the rotation of the clutch arrangement 25 around the axis of rotation 37 has the effect of creating an at least essentially ring-shaped fluid sump 160, within which dirt particles will accumulate as a result of their specific gravity, which is greater than that of the fluid medium. The dirt particles are therefore held back before the fluid medium passes through the passages 156. These dirt particles, which are produced by abrasion of the first clutch device 24, should be retained within the clutch housing 150 of the first clutch device 24. As a result, it is guaranteed that the dirt particles will not travel via the discharge line route 144 to the electric machine 44, where they could, under the action of the machine's magnetic fields, form deposits in the gap 47 between the stator 45 and the rotor 46. Deposits of this type would clog the gap 47, and thus, upon the occurrence of relative movement between the rotor 46 and the stator 45, create the risk of damage or even the destruction of the electric machine 44.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A coupling arrangement for connecting an internal combustion engine to at least one of an electric machine and a takeoff, the arrangement comprising:
a first clutch having first clutch elements and a first piston which can engage the first clutch elements to establish a working connection between the engine and the electric machine, the first piston separating a first pressure space from a first cooling space, wherein the first cooling space contains the first clutch elements;
a second clutch having second clutch elements and a second piston which can engage the second clutch elements to establish a working connection between the takeoff and at least one of the engine and the electric machine, the second piston separating a second pressure space from a second cooling space, wherein the second cooling space contains the second clutch elements;
a fluid medium supply source;
a first fluid supply line connecting said fluid medium supply source to said first pressure space;
a second fluid supply line connecting said fluid medium supply source to one of said cooling spaces;
a third fluid supply line connecting said fluid medium supply source to said second pressure space; and
a connecting line connecting the first and second cooling spaces.

2. The coupling arrangement of claim 2 wherein the clutch devices are arranged at different distances from said supply source, wherein the second fluid supply line is connected to the cooling space of the clutch device closest to the supply source.

3. The coupling arrangement of claim 1 further comprising a discharge line connected to the cooling space which is connected to the second fluid supply line.

4. The coupling arrangement of claim 2 further comprising a gearbox housing surrounding a discharge route, wherein the cooling space of the clutch device farthest from the supply source opens radially outward into the discharge route.

5. The coupling arrangement of claim 1 wherein the electric machine comprises a stator and a rotor, wherein the first and second clutches have a common coupling element which is fixed to the rotor.

6. The coupling arrangement of claim 5 wherein said common coupling element comprises a takeoff side clutch element carrier of said first clutch and a drive side coupling element carrier of said second clutch.

7. The coupling arrangement of claim 5 wherein said common coupling element comprises a wall separating the cooling space of one of said clutches from one of the pressure space and the cooling space of the other of said clutches.

8. The coupling arrangement of claim 5 further comprising a clutch housing hub which is centered on and can rotate relative to the takeoff, but essentially cannot move axially on the takeoff, wherein the coupling element is mounted on the clutch housing hub.

9. The coupling arrangement of claim 1 wherein the supply source is located adjacent to the takeoff, and wherein the second clutch is closer to the supply source than the first clutch.

10. The coupling arrangement of claim 5 wherein the first clutch comprises a drive side clutch element carrier which can rotate with respect to the common coupling element, but essentially cannot move axially.

11. The coupling arrangement of claim 10 wherein the drive-side clutch element carrier centers the takeoff.

12. The coupling arrangement of claim 5 wherein the second clutch comprises a takeoff side clutch element carrier which is centered by and can rotate relative to the common carrier element, but essentially cannot move axially.

13. The coupling arrangement of claim 10 further comprising:
a torsional vibration damper between the internal combustion engine and the first clutch, the torsional vibration damper comprising a drive side transmission element attached to the engine and a takeoff side transmission element provided with a torsion damper hub; and
a set of teeth providing a working connection between the torsion damper hub and the drive side clutch element carrier.

14. The coupling arrangement of claim 13 wherein the takeoff side transmission element further comprises a hub disk connected to the torsion damper hub by axially resilient elements.

15. The coupling arrangement of claim 10 further comprising:
a partition wall between the engine and the first clutch;
a gearbox housing surrounding a dry space between the partition wall and the engine;
a hub of the drive side clutch element carrier; and
inner and outer radial seals sealing the partition wall against the gearbox housing and the hub to isolate the dry space from the first cooling space.

16. The coupling arrangement of claim 5 wherein the common coupling element comprises spaced apart first and second radial housing walls and an axial housing wall enclosing the clutch elements and the piston.

17. The coupling arrangement of claim 16 further comprising a clutch housing hub fixed to the second radial housing wall and centered in a gearbox housing.

18. The coupling arrangement of claim 17 further comprising a support shaft located concentrically in the clutch housing hub and forming a first ring-shaped channel, said second supply line being formed by said first ring-shaped channel.

19. The coupling arrangement of claim 18 wherein the support shaft surrounds a gearbox input shaft to form a second ring-shaped channel.

20. The coupling arrangement of claim 16 wherein the first radial housing wall and the second piston form axial boundaries of the second cooling space, whereas the second housing wall and the second piston form axial boundaries of the second pressure space.

21. The coupling arrangement of the claim 16 wherein the first radial housing wall and the first piston form axial boundaries of the first pressure space.

22. The coupling arrangement of claim 1 wherein at least one of said clutches comprises an axial energy storage device which urges the respective piston toward a clutch releasing position.

23. The coupling arrangement of claim 17 wherein the first supply line is formed by a line in the gearbox housing and a line in the clutch housing hub.

24. The coupling arrangement of claim 19 further comprising a discharge line connected to the cooling space which is connected to the second fluid supply line, the second clutch comprising a takeoff side clutch element carrier having a hub, wherein the discharge line is formed by said second ring-shaped channel and a line passing through the hub.

25. The coupling arrangement of claim 19 wherein the coupling element comprises a hub having a first hub line, and wherein the third supply line is formed by a central bore in the gearbox input shaft, a radial connection in the gearbox input shaft, and a first line through the hub of the coupling element.

26. The coupling arrangement of claim 25 wherein the connecting line comprises a second line through the hub of the coupling element.

27. The coupling arrangement of claim 1 wherein the first clutch further comprise
a first clutch housing having a drive side radial housing wall, a radially outer axial housing wall, and a takeoff side radial housing wall; and
a first drive side clutch element carrier fixed to the takeoff side radial housing wall.

28. The coupling arrangement of claim 27 further comprising at least one passage in the drive side radial housing wall, said passage being spaced radially inward from the axial housing wall, said passage connecting the first cooling space to a fluid discharge route.
